(19) United States
(12) Patent Application Publication
(10) Pub. No.: US 2016/0309716 A1
(43) Pub. Date: Oct. 27, 2016

(54) Insect Control Formulation with Improved Autodissemination Characteristics

(71) Applicant: Jacques C. Bertrand, Gainesville, FL (US)

(72) Inventor: Jacques C. Bertrand, Gainesville, FL (US)

(73) Assignee: The Unites States of America as Represented by the Secretary of the Navy, Silver Spring, MD (US)

(21) Appl. No.: 14/693,615

(22) Filed: Apr. 22, 2015

(51) Int. Cl. A01N 43/40

(52) U.S. Cl. CPC A01N 43/40

(57) ABSTRACT

An insecticide composition designed for improved autodissemination. The insecticide may be used as a dry powder or a wet composition. The composition allows for better transfer of active ingredient to the target species, as well as improved stability of the active ingredient.

### CROSS-REFERENCE TO RELATED APPLICATIONS

This application claims priority to U.S. Provisional Application No. 61/982,369 filed on Apr. 22, 2014.

### BACKGROUND OF INVENTION

1. Field of Invention

The invention relates to formulations of insecticides capable of being distally transported and distributed by the target insects through the process of autodissemination, for the purpose of improved pest insect control.

2. Background Art

Insecticides are typically sprayed directly towards targeted pest insects or applied to the surfaces that have heightened chances of coming in contact with those pest insects. Contraptions containing insecticide have also been designed to attract the insects, apply the insecticide, and then allow the exposed insects to carry insecticide back to a nesting area to be further distributed. This type of dissemination of insecticide, is termed “autodissemination”, and offers a key advantage over conventional spraying methods. Autodissemination allows for the control of insect populations beyond the zone of direct insecticide application by targeting oviposition sites, and result in a consequential reduction in female insect fecundity (Caputo et al, PLoS Neg Trop Dis, 2012; 6(8)).

Stations have been developed for autodissemination of insecticide, and the insecticide formulation used with the station consisted of a mixture of pyriproxyfen-impregnated silica particles and NyGuard® IGR [10% active ingredient (a.i.)] (2-[1-methyl-2-(4-phenoxyphenoxy) ethoxy]pyridine) obtained from MGK® Chemical Co. (Minneapolis, Minn., U.S.A.) which is used as an emulsifiable concentrate (Gaugler et al, Med Vet Entomol, 2011). The insecticide was spread along the walls of the station.

Successful autodissemination of insecticides naturally depends on the ability for a particular insect to accumulate the compound, and then transport it back to a nesting site. There are some drawbacks with this autodissemination design. First, in order to have an effective application of insecticide, the insect must come into contact with a portion of the station wall, which is coated with insecticide. Second, much of the insecticide invariantly fail to adhere to the insects, or get groomed off by the insect; and third, only a fraction of the insecticide, if any, would be expected to be carried back through the full flight return to the nesting oviposition sites.

Insecticides currently employed for autodissemination tend to be large in size, ranging between 15-80 microns. So only a scant amount of insecticides make to the nesting sites with most insecticides lost during flight or due to insect grooming. When left in the powder form, the insecticide tend to cake because they are designed to be hygroscopic so they can be easily dissolved in water. When mixed in a gel formulation, the insecticide tends to be too sticky, functioning more as a classical trap, than an insecticide used for autodissemination. A better insecticide formulation addresses these problems would significantly improve the effectiveness of autodissemination approach to insect management.

As such, insecticides best designed for autodissemination would benefit from having the following qualities: 1) smaller size which prevent it from falling off the coated insect during transit, and reduce the ability of an insect to groom off or remove the insecticide, 2) the ability to adhere to a insect's body via its chemical or static electrical properties, yet not adhere so tightly as to prevent the insect from depositing it at nesting site, and 3) be detrimental to the developing insects (e.g., pupae, larvae), while is only moderately toxic, or nontoxic, to the insects transporting and disseminating the insecticides.

### SUMMARY OF THE INVENTION

The described invention relates to insecticide powder formulations that lend themselves to improved autodissemination as a result of a smaller particle size. More specifically, the invention is a fine powder (<5 μm, particle size), with adjustably high active ingredient content, that does not clump over time, and has the ability to be dissolved in aqueous solution.

There are two main embodiments of the invention: a dry powder formulation wherein the powder particles measure less than 5 micrometers, and a liquid formulation that are made from a powder insecticide. A smaller particle size allows for increased exposure to the target insect, improved transportability and better deposition at the nesting site. Both the powder and liquid formulas can be directly used in an autodissemination setting as described herein but are more likely to be dissolved or diluted using an appropriate carrier solution, such as water.

In one embodiment, the autodissemination insecticide formulation comprises the active ingredient pyriproxyfen (PPF). In addition to NYGUARD® IGR, PPF is also available from other commercial sources such as VALENT ESTEEM 35 POWDER® sold by Valent USA Corp. Pyriproxyfen (PPF) is a mosquito larvicide has been shown that does not impair adult activity, and active at extraordinarily low concentrations, which is capable of being transferred by females to other larval habitats. PPF is a highly lipophilic molecule that does not typically remain stable while dissolved in solutions, even in lipophilic solutions. Lipophilic solutions do not lend themselves to be a useful media for autodissemination anyway. Aqueous solutions or dry powder form, are preferred for autodissemination method because the contacted insect can escape the encounter more readily. Therefore, there are additional challenges of constructing an insecticide formula for autodissemination that is both stable and effective in an environment with higher temperature and high relative humidity, as many of the target insect species exists in the tropic regions.

As PPF tends to clump, and form granules or crystals, there is a challenge in creating a fine powder with a high amount of active ingredient, which requires the use of proper anticaking agent(s) and possibly a flow agent. Both anticaking agents and flow agents affect the powder flowability, or the capacity to move in a continuous and smooth way. Anticaking agent(s) are added to the inventive composition to reduce the time-related clumping (i.e., ‘caking’) of powder particles, especially between neighboring PPF particles, and help preserve flowability. Suitable anticaking agents often have high surface area, low bulk density, and can form finely particulate, inert powders. Preferred anti-caking agents may include amorphous synthetic silicas and more preferred are fumed silicas. A flow agent is a compound when added to a mixture that acts a physical lubricant, and confers increased flowability. To dissolve the powder in an aqueous solution requires the addition of a powdered surfactant as dispersing agent. The dispersing agent acts to enhance particle separation, and prevent clumping or settling of the powder in an aqueous solution. Milling these components together results in effective dry powder formulations.

To produce liquid formulations of the insecticide, a suitable solvent must be used. In one embodiment, the solvent used for the liquid-formulated insecticide compositions is methoxypolyethylene glycol. A wetting agent may be added to the liquid formulated insecticide composition to provide improved transfer of active ingredients to the target insects, as well as improved stability of the active ingredient. In an embodiment of this invention, silicone glycol is used as the wetting agent in the liquid insecticide composition, which allows the insecticide to further dissolve in an aqueous solution, and preventing the active ingredient precipitating out of solution.

### DETAILED DESCRIPTION OF PREFERRED EMBODIMENTS

Insecticides are generally compound used to control insect populations. Upon contacting the target insect, insecticide may act to modulate or block various vital functions of the insects depending on the specific biological effect of the insecticide. Common insecticides penetrate the insect's exoskeleton, and target receptors, enzymes or channels found in the nervous system of the insect, and tend to be highly lethal to the insects coming into contact with them. Examples of this type of insecticides include pyrethrum, chlorantraniliprole, and dichlorodiphenyltrichloroethane (DDT).

Instead of controlling insect population through direct toxicity, autodissemination strategy uses the targeted insect as a vehicle to carry an insecticide composition back to a nesting site where the insecticide gets further distributed to a greater number of insects and often act to interrupt the maturation process of the target insect. Chemicals that inhibit the maturation process are particularly useful for controlling insect species where the main concern is the adult insect. This is the case for certain vector insects such as mosquitos, as well as crop damaging insects such as white flies. An example of chemicals that lend themselves to autodissemination is pyriproxifen (PPF). PPF inhibits insect maturation by mimicking the insect's natural maturation hormones. PPF is an analog to the insect hormone “juvenile hormone”. However, currently available formulations (e.g., VALENT ESTEEM 35 POWDER® sold by Valent USA Corp) tend to adhere or cake, and form 15-80 micron size clumps, which are not useful for autodissemination. The inventive formulation is small in particle size, while offering excellent anti-caking and flowability. Flowabilty is the capacity to move by flow that characterizes fluids and loose particulate solids. The flowability characteristic of a powder is directly related to both the physical properties of the material itself, as well as the specific processing conditions in the handling system.

### Example 1

### Mixable Dry Powder Formulas of Autodissemination Insecticides

For a dry powder formulation of this invention, whether used for direct dissemination or as dissolved in an aqueous medium, there is a need to prevent caking and clumping of the active ingredient, and maintain overall powder flow. Table 1 provides a general formulation of an inventive powder composition. PPF is used as the active ingredient. The powder composition includes hydrophilic flow agents and anticaking agents that confer advantageous flowability of the composition even in the humid conditions. A dispersing agent may also be included in this powder composition, which would allow the powder composition to be dissolved in a liquid, such as water, and prevent clumping of the powder within the liquid solution.

Preparation of the powder formula is prepare by milling the components listed in Table 1 for 24 hours in a one quart ball mill containing ⅛ inch stainless steel balls, and rotating at 40 rpm. The resulting powder measures 2-4 microns, a suitable size for autodissemination, and can be easily dissolving in water.

The specific inventive powder formulation can be prepared in a number of ways. The formula components may be used at various percentages for a given customizable formulation. Examples of dry powder formulations are described in Tables 2, 3, and 4. Several hydrophilic silicas may be used as appropriate flow and anticaking agents. Many hydrophilic silicas exhibit properties that make them suitable as both types of agents. Evonik Industries offer a commercial source for these ingredients. SIPERNAT® 320 DS silicone particles used in specific dry powder formula examples A and C (Tables 2 and 4) are well-suited to provide the mechanical lubrication as a flow agent because of its extra-fine particle size (especially after milling) and high specific surface area (Pre-milling size and specific surface area are: 7.5 μm and 175 m²/g, respectively). Other hydrophilic silicas available from Evonik that may be used as appropriate flow agents (with approximate pre-milling particle sizes) are: SIPERNAT® 22 LS (8 μm), 25 (14 μm), 33 (115 μm), 35 (9 μm), 50 (40 μm), 101 M (6.5 μm), 320 DS (7.5 μm), 340 (30 μm), 500 LS (6 μm), 2200 (320 μm), and FPS-5 (5.8 μm).

To reduce clumping of adjacent PPF particles, an anticaking agent with a small particle size and extra-high specific surface area (6 μm and 475 m²/g, respectively) may be also added. For example, SIPERNAT® 500 LS is used in specific dry powder formula examples A-C, Tables 2-4. Other silicas that could be used as appropriate anticaking agents and help improve powder flowability are: SIPERNAT® 22 (110 μm), 22 LS, 22 S (11.5 μm), 50 S, as well as 609 (9.5 μm) and SIPERNAT® 500 LS. As mentioned above, the powder formula may be prepared by milling the components for 24 hours in a one quart ball mill containing ⅛ inch stainless steel balls, and rotating at 40 rpm.

In addition to the benefit of having powder formulation soluble in water, pest insects are commonly found in tropical areas that have high temperature and humidity. The effectiveness and utility of a particular formulation will therefore depend in part on how that formulation behaves in an aqueous environment. The inclusion of one or more anionic surfactant dispersing agents allows the powder formulations to be used in either a dry or aqueous form, by enabling the formulated powder's dissolution in water or a similar medium.

TABLE 1
General dry powder formula

| Chemical | | | | |
|---|---|---|---|---|
| class | % | Example | Company | Function |
| Growth | 1-80 | Pyriproxyfen | McLaughlin- | Active |
| regulator | | | GormleyKing | ingredient |
| | | | Co.(MGK) | |
| Hydrophilic | 0.0-50 | SIPERNAT ® | Evonik | Flow |
| amorphous | | 320 DS | Industries | agent |
| silica | | | | |
| Hydrophilic | 1-50 | SIPERNAT ® | Evonik | Anti- |
| amorphous | | 500 LS | Industries | caking, |
| silica | | | | flow agent |
| Modified | 1-50 | ATLOX | Croda Inc. | Dispersing |
| Styrene | | METASPERSE ™ | | Agent |
| Acrylic | | 550S-PW-(AP) | | |
| Copolymer | | | | |

TABLE 2
Specific dry powder formula A

| Chemical | | | | |
|---|---|---|---|---|
| class | % | Example | Company | Function |
| Growth | 60 | Pyriproxyfen | McLaughlin- | Active |
| regulator | | | GormleyKing | ingredient |
| | | | Co.(MGK) | |
| Hydrophilic | 15 | SIPERNAT ® | Evonik | Flow |
| amorphous | | 320 DS ® | Industries | agent |
| silica | | | | |
| Hydrophilic | 10 | SIPERNAT ® | Evonik | Anti- |
| amorphous | | 500 LS | Industries | caking, |
| silica | | | | flow agent |
| Modified | 15 | ATLOX | Croda Inc. | Dispersing |
| styrene | | METASPERSE ™ | | agent |
| Acrylic | | 550S-PW-(AP) | | |
| Copolymer | | | | |

TABLE 3
Specific dry powder formula B

| Chemical | | | | |
|---|---|---|---|---|
| class | % | Example | Company | Function |
| Growth | 70 | Pyriproxyfen | McLaughlin- | Active |
| regulator | | | GormleyKing | ingredient |
| | | | Co.(MGK) | |
| Hydrophilic | 20 | SIPERNAT ® | Evonik | Anti- |
| amorphous | | 500 LS | Industries | caking, |
| silica | | | | flow agent |
| Sodium | 4 | S529 ® | Fisher | Dispersing |
| lauryl | | | Scientific | Agent 1 |
| sulfate | | | | |
| Modified | 6 | ATLOX | Croda Inc. | Dispersing |
| styrene | | METASPERSE ™ | | Agent 2 |
| acrylic | | 550S-PW-(AP) | | |
| copolymer | | | | |

TABLE 4
Specific dry powder formula C

| Chemical | | | | |
|---|---|---|---|---|
| class | % | Example | Company | Function |
| Growth | 80 | Pyriproxyfen | McLaughlin- | Active |
| regulator | | | GormleyKing | ingredient |
| | | | Co.(MGK) | |
| Hydrophilic | 10 | SIPERNAT ® | Evonik | Flow |
| amorphous | | 320 DS ® | Industries | agent |
| silica | | | | |
| Hydrophilic | 4 | SIPERNAT ® | Evonik | Anti- |
| amorphous | | 500 LS ® | Industries | caking, |
| silica | | | | flow agent |
| Modified | 6 | ATLOX | Croda Inc. | Dispersing |
| styrene | | METASPERSE ™ | | Agent 2 |
| acrylic | | 550S-PW-(AP) | | |
| copolymer | | | | |

### Example 2

### Liquid Formulas for Autodissemination Insecticides

Due to a liquid's intrinsic ability to coat a surface as well as many insects' natural attraction to liquids, a liquid insecticide solution may often be superior choice in pest management for certain types of insects than a powder. Furthermore, a concentrated liquid formulation is advantageous for easy storage and transportation of the insecticide, as that it can be diluted to the proper strength only before application. Therefore, one embodiment of the invention is a concentrated insecticide solution.

Due to PPF being a hydrophobic molecule, the use of a hydrophobic or amphipathic solvent is required for the liquid composition of this inventio. However, PPF also has the tendency to form crystalized aggregates in many oils upon cooling. For example, mineral oil, castor oil, corn oil, polyethylene glycol, propylene glycol, soy oil, as well as canola oil are all not suitable solvents due to this reason. The choice of solvents that can maintain the insecticide in a dissolved form at ambient temperatures becomes more limited.

An appropriate carrier solvent is needed as a vehicle for the insecticide. The carrier solvent itself should not be toxic to the insect for the autodissemination activity to occur, which presents a further constraint. Additionally, as the placement of the insecticide mainly occurs in an outdoor setting, environmental impact of the solvent should be minimal to none. As such, in addition to the active ingredient, the inventive liquid composition further include a suitable nonreactive carrier solvent, such as methoxypolyethylene glycol, as well as a nonreactive wetting agent (e.g., an organically modified siloxane surfactant such as a silicone glycol). The wetting agent is utilized to assist the wetting of silica (if present) and to improve the spread-out of active ingredient when it is applied as a spray solution, or when applied as a dust, after exposure to moisture via rain, dew, or irrigation. The wetting agent often serves to reduce the surface tension at the water-solid interface and therefore, increase the tendency of the water to contact the complete surface of the active ingredient particles. Both anionic and nonionic surfactants are useful. Examples of anionic surfactants include alkyl polyether alcohol sulfates, arylalkyl polyether alcohol sulfates, arylalkyl sulfonates, alkylnaphthalene sulfonates, and alkyl phenoxybenzene disulfonates. Nonionic surfactants include arylalkyl polyether alcohols, alkyl polyether alcohols, polyoxyethylene fatty acid esters, polyethylene sorbitan fatty acid esters, polyalkylene oxide block copolymers, polyalkylene oxide block copolymer monohydric alcohols and polyalkylene oxide block copolymer alkyl phenols.

The general formula for a liquid composition of an appropriate PPF-based dilutable autodissemination insecticide is described in Table 5.

TABLE 5
General liquid band formula

| Chemical | | | | |
|---|---|---|---|---|
| class | % | Example | Company | Function |
| Growth | 1-30 | Pyriproxyfen | McLaughlin- | Active |
| regulator | | | GormleyKing | ingredient |
| | | | Co.(MGK) | |
| Methoxy | 1-90 | Carbowax ™ | Dow Chemical Co. | Carrier |
| polyethylene | | MPEG 550 | | solvent |
| glycol | | | | |
| Organo | 1-30 | BREAK-THRU | Evonik | Wetting |
| modified | | OE ® 441 | Goldschmidt Corp | agent |
| polysiloxane | | | | |

Specific examples of concentrated liquid formulas are presented in Tables 6, 7, 8 and 9.

TABLE 6
Specific liquid formula A

| Chemical | | | | |
|---|---|---|---|---|
| class | % | Example | Company | Function |
| Growth | 20 | Pyriproxyfen | McLaughlin- | Active |
| regulator | | | GormleyKing | ingredient |
| | | | Co.(MGK) | |
| Methoxy | 60 | Carbowax ™ | Dow Chemical Co. | Carrier |
| polyethylene | | MPEG 550 | | solvent |
| glycol | | | | |
| Organo | 20 | BREAK-THRU | Evonik | Wetting |
| modified | | OE ® 441 | Goldschmidt Corp | agent/Water |
| polysiloxane | | | | soluble oil |
| | | | | enhancer |

TABLE 7
Specific liquid formula B

| Chemical | | | | |
|---|---|---|---|---|
| class | % | Example | Company | Function |
| Growth | 30 | Pyriproxyfen | McLaughlin- | Active |
| regulator | | | GormleyKing | ingredient |
| | | | Co.(MGK) | |
| Methoxy | 50 | CARBOWAX ™ | Dow Chemical Co. | Carrier |
| polyethylene | | MPEG 350 | | solvent |
| glycol | | | | |
| Organo | 20 | BREAK-THRU | Evonik | Wetting |
| modified | | OE ® 441 | Goldschmidt Corp | agent |
| polysiloxane | | | | |

TABLE 8
Specific liquid formula C

| Chemical | | | | |
|---|---|---|---|---|
| class | % | Example | Company | Function |
| Growth | 30 | Pyriproxyfen | McLaughlin- | Active |
| regulator | | | GormleyKing | ingredient |
| | | | Co.(MGK) | |
| Methoxy | 50 | CARBOWAX ™ | Dow Chemical Co. | Carrier |
| polyethylene | | MPEG 350/550 | | solvent |
| glycol | | (50/50 mix) | | |
| Organo | 20 | BREAK-THRU | Evonik | Wetting |
| modified | | OE ® 441 | Goldschmidt Corp | agent |
| polysiloxane | | | | |

TABLE 9
Specific liquid formula C

| Chemical | | | | |
|---|---|---|---|---|
| class | % | Example | Company | Function |
| Growth | 40 | Pyriproxyfen | McLaughlin- | Active |
| regulator | | | GormleyKing | ingredient |
| | | | Co.(MGK) | |
| Methoxy | 40 | Carbowax ™ | Dow Chemical Co. | Carrier |
| polyethylene | | MPEG 350/550 | | solvent |
| glycol | | (50/50 mix) | | |
| Organo | 20 | BREAK-THRU | Evonik | Wetting |
| modified | | OE ® 441 | Goldschmidt Corp | agent |
| polysiloxane | | | | |

1) A powder composition comprising a pyriproxifen, at least one anticaking agent, and at least one dispersing agent.

2) The composition of claim 1, wherein the amounts of pyriproxyfen, anticaking agent, and dispersing agent are 0.01 to 80% by weight, 1 to 50% by weight, and 1 to 50% by weight, respectively.

3) The composition of claim 1, wherein said composition further contains 2 or more flow agents in the amount of 1 to 50% by total weight.

4) The composition of claim 3, wherein the flow agent and anticaking agents are hydrophilic silicas.

5) The composition of claim 1, wherein said powder composition comprising two or more dispersing agents that collectively total 1 to 50% by weight.

6) The composition of claim 1, wherein the composition comprises more than one anticaking agents.

7) The composition of claim 1, wherein the dispersing agent is an anionic surfactant.

8) The composition of claim 3, wherein said composition further comprises one or more flow agents that enhance flowability via physical lubrication, which is selected from the group consisting of: SIPERNAT® 22 LS (8 μm), 25 (14 μm), 33 (115 μm), 35 (9 μm), 50 (40 μm), 101 M (6.5 μm), 320 DS (7.5 μm), 340 (30 μm), 500 LS (6 μm), 2200 (320 μm), FPS-5 (5.8 μm) and a combination thereof.

9) A liquid composition comprised of the insecticide pyriproxyfen, a carrier solvent, and a water soluble wetting agent.

10) The composition of claim 9, wherein the amounts of pyroproxifen, carrier solvent, and water soluble wetting agent are 0.01 to 30% by weight, 1 to 90% by weight, and 1 to 30% by weight, respectively.

11) The composition of claim 10, wherein the carrier solvent is a methoxypolyethylene glycol, or a mixture comprising methoxypolyethylene glycol.

12) The composition of claim 10, whereby the wetting agent is silicone glycol.

13) A method for controlling insect population comprising applying the insecticide composition of claim 1 using an autodissemination apparatus.

14) A method for controlling insect population comprising applying the insecticide composition of claim 9 using an autodissemination apparatus.
